(19) United States
(12) Patent Application Publication
(10) Pub. No.: US 2019/0118417 A1
(43) Pub. Date: Apr. 25, 2019

(54) SYSTEM, COMPONENTS AND METHODOLOGIES FOR ADDITIVE MANUFACTURED TOOLS FOR COMPRESSION MOLDING

(71) Applicant: VOLKSWAGEN AKTIENGESELLSCHAFT, Wolfsburg (DE)

(72) Inventors: Hendrik MAINKA, Athens, TN (US); Michael RADEMACHER, Chattanooga, TN (US); Thomas Wolfgang Clemens LADUCH, Cleveland, TN (US)

(21) Appl. No.: 15/790,428

(22) Filed: Oct. 23, 2017

(51) Int. Cl. B29C 33/38; B29C 64/118; B29C 43/02; B29C 43/36; B29C 43/58

(52) U.S. Cl. CPC B29C 33/3842; B29C 64/118; B29K 2307/04; B29C 43/36; B29C 43/58; B29C 43/02

(57) ABSTRACT

A system and method are provided for producing production grade prototype vehicle parts. The system uses large-scale printing to create a tooling, which is strong enough to subsequently be used in a compression molding machine to mold prototype vehicle parts that have similar mechanical properties to production grade vehicle parts.

### BACKGROUND

The present disclosure relates to systems, components and methodologies for producing and using tools in compression molding. In particular, the present disclosure relates to systems, components and methodologies for using additive manufacturing to produce tools that are used in compression molding to produce production-grade vehicle components.

### SUMMARY

According to the present disclosure, a compression molding tooling is provided for producing production-grade prototype vehicle components. The tooling has at least one die formed using additive manufacturing technologies.

In some embodiments, the tooling may comprise a first die and a second die configured to be secured to upper and lower platforms of a compression molding machine as part of a system to mold the vehicle components.

In illustrative embodiments, the tooling may be formed from layers of fiber reinforced thermoplastics. The dies may operate at pressures of 750 to 1500 psi and at temperatures of 200 to 400 degrees Fahrenheit to form the vehicle components. In some embodiments, the dies are operable to form the production-grade vehicle component using Sheet Molding Compound (SMC) or Bulk Molding Compound (BMC). In some embodiments, the additive manufacturing technologies used are one of Big Area Additive Manufacturing (BAAM), Large Scale Additive Manufacturing (LSAM), Fused Deposition Modeling (FDM, Fused Filament Fabrication (FFF), or other technologies

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIGS. 1A-1D constitute a diagrammatic view of an exemplary process for making and using a tool to make a vehicle component showing a first point where a fiber reinforced thermoplastic is formed into pellets, a second point where the pellets are fed into a mobile extruder that prints extruded layers in a pre-programmed pattern onto a print bed forming a tool, a third point where formed tool surface may be further machined, and a fourth point where upper and lower tools are compressed together to form a vehicle component.

FIG. 1A is a compounding of a thermoplastic providing thermoplastic material granules into an extruder and adding fibers to product a fiber reinforced thermoplastic material that is formed into pellets;

FIG. 1B illustrates how the pellets may be fed into a large-scale printer in an extruder, and the gantry is controlled to move the extruder and a corresponding print bed to output extruded layers onto the print bed in a predetermined pattern to form a tool;

FIG. 1C depicts how further machining may be performed on the tool compression surface; and

FIG. 1D illustrates how resulting tools installed on platforms of a compression molding machine mold a SMC charge to form a vehicle component.

FIG. 2 is a flow diagram of the tool producing process of FIGS. 1A-1C; and

FIG. 3 is a flow diagram of the vehicle component producing process using the systems of FIG. 1D.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

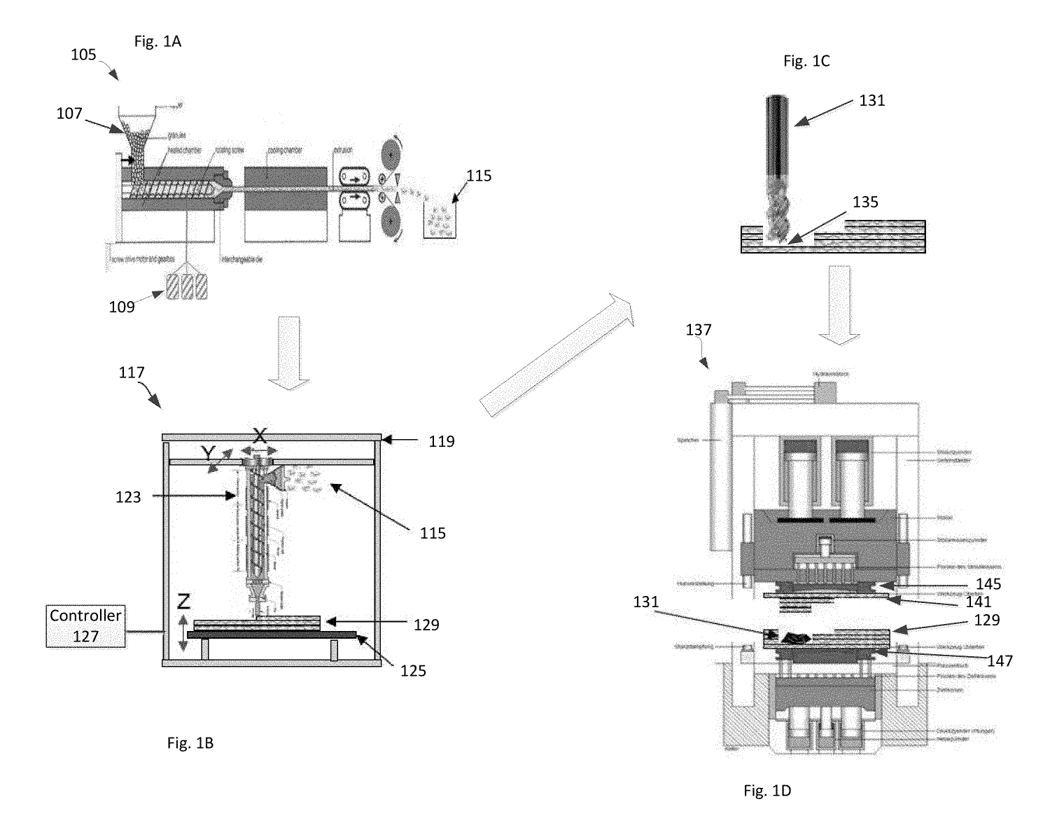

FIGS. 1A-1D constitute a diagrammatic view of an exemplary vehicle prototyping production system that consists of a compounder 105, a large-scale printer 117, a machining component 131, and a compression molding machine 137.

The additive manufacturing system of FIGS. 1A-C depict how a tool, or die, 129 may be created using additive manufacturing such as BAAM or LSAM, methodologies disclosed herein.

In FIG. 1A, a thermoplastic material 107 and a fiber reinforcement 109 may be coextruded and compounded into fiber reinforced thermoplastic pellets 115. The pellets 115 may be fed into a large-scale printer 117 in FIG. 1B. This large-scale printer 117 may be coupled to a controller 127 that is programmed to control operation of the large-scale printer. The large-scale printer 117 may include a gantry frame 119 that supports an extruder 123 and a print bed 125. Extruder 123 may be movable along the X and Y axis as depicted. The print bed 125 may be movable along the Z-axis. Controller 127 may control movement of the extruder 123 and the print bed 125. Alternatively, the compounder and printer can be combined into a direct or “in-line” extrusion system in which the compounding of the thermoplastic material and the fiber reinforcement and extrusion onto the print bed are combined into a single step thereby eliminating the need to pelletize and re-melt the compounded fiber reinforced thermoplastic material.

The controller 127 may be implemented in one or a combination of hardware, firmware, and software and implemented, at least in part, as instructions stored on a machine-readable medium, which may be read and executed by a computing platform, e.g., a processor or computer, to perform the operations described herein.

Pellets 115 may be fed into the extruder 123 and may be extruded so that the carbon fibers may be orientated along the longitudinal axis of the extruder, or the Z-axis. The extrusion may be extruded into layers 129 that may be layered on top of each other in a predetermined pattern according to manipulation of the extruder 123 and print bed 125 by controller 127 to form a tool 129. Formed tool 129 may optionally be further machined via machining component 131 as seen in FIG. 1C. A tool such as a drill 131 or may be manually or robotically deployed to further define a die surface 135 of the tool or die. The process of FIG. 1A-C may be repeated to form a corresponding opposite tool 141 that will form the opposite wall of the compression mold.

As can be seen in FIG. 1D, the tools 129, 141 may be mounted to upper and lower platforms 145, 147 of a compression molding machine system 143. A sheet molding compound (SMC) charge 131 may be manually or robotically deposited in the lower die 129. A controller of the system 143 may control one or more heating components (not shown) to supply heat to the tools 129, 141, of the machine 143 and compress the charge between the upper and lower tools 129, 141 to produce a vehicle component. This compression may be repeated to produce a plurality of identical vehicle components. The resulting vehicle components may be of production level quality and may be used in vehicle prototyping and vehicle testing. The resulting vehicle components may include, for example, battery boxes for electric vehicles, vehicle panels, doors, interiors, and other automotive components. Components for boats, planes, trains, and vehicles other than automotive vehicles may also be made using the systems and methods disclosed herein.

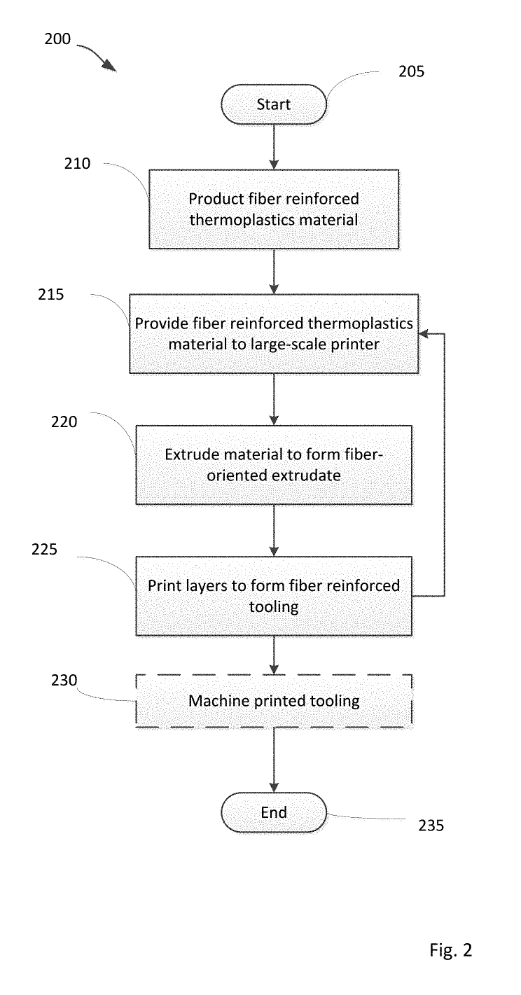

A method of manufacturing a tool for compression molding 200 in accordance with this disclosure is provided in FIG. 2. The method begins at 205, and control proceeds to 210 at which an optional compounding operation for producing the material used to make the tool is performed. In this operation, a thermoplastic material and a fiber reinforcement may be coextruded and formed into solid fiber reinforced thermoplastic pellets. The material may be formed into any of a variety of shapes and sizes because the material may be fed into an extruder of a large-scale printer. The composition of this fiber reinforced material may be in the range of 40-80% percent by weight thermoplastic and 20-60% percent by weight fibers. Suitable thermoplastic materials may include one or more of PAEK, PEEK, PPS, high temperature nylon, PEI (Ultem), PPSU, PEKK, and PESU. Suitable fiber reinforcing materials may include nylon and/or carbon fiber. The compounded materials result in a fiber reinforced material that is able to withstand temperatures up to and including 400 degrees Fahrenheit and pressures up to and including 1500 psi.

The fiber reinforced thermoplastics material is next provided to a large-scale printer at 215. The printer may be programmed to print a particular three-dimensional tool for an automotive component. The printer may be programmed by a numerical (NC) programming machine based on a CAD model of the tool. The fiber reinforced thermoplastics material may then be extruded to form a fiber-oriented extrudate in which the fibers are oriented in the machine, or longitudinal direction at 220. The oriented extrudate may then be layered or “printed” on a print bed located opposite an exit point of the extruder in a particular layered configuration based on the execution of the program at 225. The program may be instructions or code that are software executed on a computer, which in turn translates the extruder along X and Y axes and the print bed along the Z axis. Layers may be continuously printed until the tooling, or a “near-tooling” is printed. In some instances, it may be desirable to further machine, or finish the contact surface of the tool at 230 before the production is complete at 235. The printing through the optional finishing may be repeated with further instructions or code for printing the opposing tool of the compression mold. This method of manufacture may in some instances, depending on material used, be up to 85% cheaper than the cost of manufacturing conventional tools, such as aluminum cast prototyping tools.

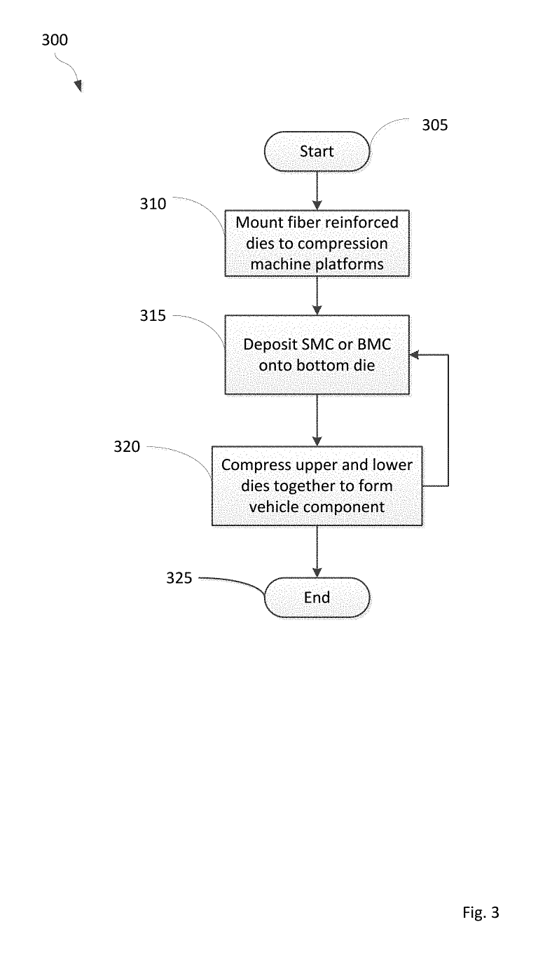

FIG. 3 illustrates a method 300 for manufacturing a vehicle prototype part using the printed tools. As shown in FIG. 3, the process starts at 305 and control proceeds to 310 at which mounting the fiber reinforced tools, or dies, is performed, wherein the fiber reinforced tools have been made according to the method illustrated in FIG. 2.

At 310, the dies may be mounted to top and bottom platforms of a compression machine. Subsequently, control proceeds to 315, at which a material used to make production-grade vehicle parts may be deposited onto the bottom die. This material may be one of Sheet Molding Compound (SMC) or Bulk Molding Compound (BMC) or a similar material. The upper and lower dies may then be heated and compressed via hydraulics to close around the material to mold the material into the vehicle part at 320. The dies may operate at pressures of 1500 psi and at temperatures of 400 degrees Fahrenheit to mold the material. This process may be repeated multiple times to create multiple of the same production grade prototype vehicle parts at 325.

In accordance with the disclosed embodiments, these printed dies may be operated in the compression molding machine to produce up to 100 vehicle parts without failing. This provides increased technical utility and advantage over conventional tools for prototyping vehicle body parts because use of such conventional tools is limited by cost and functionality. Additionally, the printed tool can be recycled by grinding it, pelletizing it and reprinting the material into another tool.

For example, tools, such as aluminum cast tools, which may be used to produce production grade prototypes in automotive engineering are expensive and have prohibitively long lead times (up to several months). Existing solutions, such as rapid prototyping, can reduce the lead times, but are limited by size (e.g., a few cubic inches) or produce prototypes with mechanical properties far inferior to actual production materials. Likewise, current 3D printing solutions provide material characteristics far inferior to actual production materials.

The methods described in FIGS. 2-3, for creating a tool using Big Area Additive Manufacturing (BAAM), LSAM, FDM, FFF or large-scale 3D printing, and overcome the above-identified problems by creating the resultant production grade prototype and taking approximately one fourth the amount of time it takes for conventional methods for making tools and prototype parts. Production grade prototypes or near production grade prototypes provide vehicle components that are able to be subject to testing to determine how a corresponding vehicle component on the market will behave.

Exemplary embodiments have been discussed in detail herein. While specific exemplary embodiments have been discussed, it should be understood that this is done for illustration purposes only. In describing and illustrating the exemplary embodiments, specific terminology is employed for the sake of clarity. However, the embodiments are not intended to be limited to the specific terminology so selected. Persons of ordinary skill in the relevant art will recognize that other components and configurations may be used without departing from the true spirit and scope of the embodiments. It is to be understood that each specific element includes all technical equivalents that operate in a similar manner to accomplish a similar purpose. The examples and embodiments described herein are non-limiting examples.

Embodiments of the present invention may include apparatus/systems for performing the operations disclosed herein. An apparatus/system may be specially constructed for the desired purposes, or it may comprise a general purpose apparatus/system selectively activated or reconfigured by a program stored in the apparatus/system.

Embodiments of the invention may also be implemented in one or a combination of hardware, firmware, and software. They may be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM), random access memory (RAM), magnetic disk storage media, optical storage media, flash memory devices including thumb drives and solid state drives, and others.

In the following description and claims, the terms “computer program medium” and “computer readable medium” may be used to generally refer to media such as, but not limited to removable storage drives, a hard disk installed in hard disk drive, and the like, etc. These computer program products may provide software to a computer system. Embodiments of the invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Further, the term computer readable medium is meant to refer to any machine-readable medium (automated data medium) capable of storing data in a format readable by a mechanical device. Examples of computer-readable media include magnetic media such as magnetic disks, cards, tapes, and drums, punched cards and paper tapes, optical disks, barcodes and magnetic ink characters. Further, computer readable and/or writable media may include, for example, a magnetic disk (e.g., a floppy disk, a hard disk), an optical disc (e.g., a CD, a DVD, a Blu-ray), a magneto-optical disk, a magnetic tape, semiconductor memory (e.g., a non-volatile memory card, flash memory, a solid state drive, SRAM, DRAM), an EPROM, an EEPROM, etc.).

While various exemplary embodiments have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

Thus, disclosed embodiments provide a compression molding tooling equipment for producing production-grade vehicle components, wherein the equipment includes a controller for controlling operating pressure and temperature for molding at approximately 1500 psi and approximately 400 degrees Fahrenheit, respectively, and a means for molding a vehicle component out of sheet molding compound (SMC) or a bulk molding compound (BMC) formed by additive manufacturing such as BAAM, LSAM, FDM, or FFF; so that the means for molding can withstand the operating pressure and temperature applied to the molding under the control of the controller. The means for molding may comprise an upper die and a corresponding lower die, and the vehicle component is formed therebetween. The means may comprise extruded layers of a fiber-reinforced thermoplastic material forming a die.

The fiber-reinforced thermoplastic material includes one or more of PAEK, PEEK, and PPS, high temperature nylon, PEI, PPSU, PEKK, PESU The fibers may be carbon fibers. The fiber-reinforced thermoplastic may include approximately 50% by weight carbon fiber and 50% by weight thermoplastic. The die may be sized and shaped to produce one of a battery box for an electric vehicle, vehicle door, vehicle body panel, or vehicle interior or other structural component.

Further, in accordance with the disclosed embodiments, a method of making a tooling for compression molding equipment is provided wherein a fiber-reinforced thermoplastic material is provided and extruded to orient the fibers in a machine direction, wherein the method includes printing the extrudate using additive manufacturing such as BAAM, LSAM, FDM, FFF to produce a tooling that operates in a compression molding machine at at least 750-1500 psi and 200-400 degrees Fahrenheit. In such a method, the fiber-reinforced thermoplastic material may include one or more of PAEK, PEEK, PPS, high temperature nylon, PEI, PPSU, PEKK, PESU, wherein the fibers are carbon fibers. The fiber-reinforced thermoplastic material may include approximately 20-60% by weight carbon fiber and 40-80% by weight thermoplastic material.

Further, in accordance with the disclosed embodiments, a method of prototyping a production-grade vehicle component may include producing at least one fiber-reinforced thermoplastic tooling using additive manufacturing such as BAAM, LSAM, FDM, or FFF, installing the at least one tooling on upper and lower platforms of the compression molding equipment, providing a sheet molding compound (SMC) charge on the lower platform tooling, and compressing the upper and lower tooling platforms on the SMC charge to produce a production-grade vehicle component while controlling pressure and temperature applied to the tooling at 750-1500 psi and 200-400 degrees Fahrenheit, respectively. That method may include configuring the upper and lower platform toolings to operate at 1500 psi and 400 Fahrenheit and to be compressed repeatedly to form multiple production-grade vehicle components. In that method the fiber-reinforced thermoplastic tooling may include carbon fibers and one or more of PAEK, PEEK, PPS, high temperature nylon, PEI, PPSU, PEKK, and PESU. Further, the fiber-reinforced thermoplastic material may include approximately 20-60% by weight carbon fiber and 40-80% by weight thermoplastic. Such a method may be used to produce one of a vehicle door, vehicle body panel, or vehicle interior component.

Further disclosed embodiments may provide a compression molding tooling for producing production-grade vehicle components, the tooling including at least one die sized and shaped to mold a vehicle component, wherein the at least one die is configured for repeated use to produce the vehicle component from Sheet Molding Compound (SMC) or Bulk Molding Compound (BMC) or similar material, wherein the die is formed using additive manufacturing, such as BAAM, LSAM, FDM, or FFF. Such a die may include an upper die and a corresponding lower die, wherein the vehicle component is formed therebetween. The die may be formed of extruded layers of a fiber-reinforced thermoplastic material.

The fiber-reinforced thermoplastic material may include one or more of PAEK, PEEK, and PPS and the fibers reinforcing the thermoplastic may be carbon fibers. The fiber-reinforced thermoplastic includes approximately 20-60% by weight carbon fiber and 40-80% by weight thermoplastic. Further, the tooling is configured to withstand operating pressures of at least 750-1500 psi and temperatures of at least 200-400 degrees Fahrenheit and the die may be sized and shaped to produce one of a vehicle door, vehicle body panel, or vehicle interior component. A compression molding tooling for producing production-grade vehicle components from sheet molding compound (SMC) or a bulk molding compound (BMC), the tooling being formed by additive manufacturing such as BAAM, LSAM, FDM, and FFF, and configured to withstand operating pressures of 750-1500 psi and temperatures of 200-400 degrees Fahrenheit

1. A compression molding tooling equipment for producing production-grade vehicle components, the equipment comprising:
a controller for controlling operating pressure and temperature for molding at 750-1500 psi and 200-400 degrees Fahrenheit, respectively,
a means for molding a vehicle component out of sheet molding compound (SMC) or a bulk molding compound (BMC) formed by additive manufacturing so that the means for molding can withstand the operating pressure and temperature applied to the molding under the control of the controller.

2. The compression molding tooling equipment of claim 1, wherein the additive manufacturing comprises one of Big Area Additive Manufacturing (BAAM), Large Scale Additive Manufacturing (LSAM), and Fused Deposition Modeling (FDM, Fused Filament Fabrication (FFF).

3. The compression molding tooling equipment of claim 1, wherein the means comprises an upper die and a corresponding lower die, and the vehicle component is formed therebetween.

4. The compression molding tooling equipment of claim 1, wherein the means comprises extruded layers of a fiber-reinforced thermoplastic material forming a die.

5. The compression molding tooling equipment of claim 3, wherein the fiber-reinforced thermoplastic material includes one or more of PAEK, PEEK, PPS, high temperature nylon, PEI, PPSU, PEKK, and PESU.

6. The compression molding tooling equipment of claim 3, wherein the fibers are carbon fibers.

7. The compression molding tooling equipment of claim 3, wherein the fiber-reinforced thermoplastic includes approximately 20-60% by weight carbon fiber and 40-80% by weight thermoplastic.

8. The compression molding tooling equipment of claim 1, wherein the die is sized and shaped to produce one of a battery box, vehicle door, vehicle body panel, vehicle interior, or structural component.

9. A method for making a tooling for compression molding equipment, the method comprising:
providing a fiber-reinforced thermoplastic material;
extruding the fiber-reinforced thermoplastic material to orient the fibers in a machine direction; and
printing the extrudate using additive manufacturing to produce a tooling that operates in a compression molding machine at 750-1500 psi and 200-400 degrees Fahrenheit.

10. The method of claim 9, wherein the additive manufacturing is one of Big Area Additive Manufacturing (BAAM), Large Scale Additive Manufacturing (LSAM), and Fused Deposition Modeling (FDM, Fused Filament Fabrication (FFF).

11. The method of claim 9, wherein the fiber-reinforced thermoplastic material includes one or more of PAEK, PEEK, PPS, high temperature nylon, PEI, PPSU, PEKK, and PESU.

12. The method of claim 9, wherein the fibers are carbon fibers.

13. The method of claim 9, wherein the fiber-reinforced thermoplastic material includes approximately 20-60% by weight carbon fiber and 40-80% by weight thermoplastic material.

14. A method of prototyping a production-grade vehicle component, the method comprising:
producing at least one fiber-reinforced thermoplastic tooling using additive manufacturing,
installing the at least one tooling on upper and lower platforms of the compression molding equipment;
providing a sheet molding compound (SMC) charge on the lower platform tooling; and
compressing the upper and lower tooling platforms on the SMC charge to produce a production-grade vehicle component while controlling pressure and temperature applied to the tooling at 750-1500 psi and 200-400 degrees Fahrenheit, respectively.

15. The method of claim 14, wherein the additive manufacturing is one of Big Area Additive Manufacturing (BAAM), Large Scale Additive Manufacturing (LSAM), and Fused Deposition Modeling (FDM, Fused Filament Fabrication (FFF).

16. The method of claim 14, wherein the upper and lower platform toolings are configured to operate at 750-1500 psi and 200-400 degrees Fahrenheit and to be compressed repeatedly to form multiple production-grade vehicle components.

17. The method of claim 14, wherein the fiber-reinforced thermoplastic tooling comprises carbon fibers and one or more of PAEK, PEEK, PPS, high temperature nylon, PEI, PPSU, PEKK, and PESU.

18. The method of claim 14, wherein the fiber-reinforced thermoplastic material includes approximately 20-60% by weight carbon fiber and 40-80% by weight thermoplastic.

19. The method of claim 14, wherein the tooling produces one of a battery box vehicle door, vehicle body panel, vehicle interior, or structural component.

20. A compression molding tooling for producing production-grade vehicle components, the tooling comprising:
at least one die sized and shaped to mold a vehicle component, wherein the at least one die is configured for repeated use to produce the vehicle component from Sheet Molding Compound (SMC) or Bulk Molding Compound (BMC),
wherein the die is formed using additive manufacturing.

21. The compression molding tooling of claim 20, wherein the additive manufacturing is one of Big Area Additive Manufacturing (BAAM), Large Scale Additive Manufacturing (LSAM), Fused Deposition Modeling (FDM, and Fused Filament Fabrication (FFF).

22. The compression molding tooling of claim 20, wherein the at least one die comprises an upper die and a corresponding lower die, wherein the vehicle component is formed therebetween.

23. The compression molding tooling of claim 20, wherein the die is formed of extruded layers of a fiber-reinforced thermoplastic material.

24. The compression molding tooling of claim 23, wherein the fiber-reinforced thermoplastic material includes one or more of PAEK, PEEK, PPS, high temperature nylon, PEI, PPSU, PEKK, and PESU.

25. The compression molding tooling of claim 23, wherein the fibers reinforcing the thermoplastic are carbon fibers.

26. The compression molding tooling of claim 25, wherein the fiber-reinforced thermoplastic includes approximately 20-60% by weight carbon fiber and 40-80% by weight thermoplastic.

27. The compression molding tooling of claim 20, wherein the tooling is configured to withstand operating pressures of 750-1500 psi and temperatures 200-400 degrees Fahrenheit.

28. The compression molding tooling of claim 20, wherein the die is sized and shaped to produce one of a battery box, vehicle door, vehicle body panel, vehicle interior, or structural component.

29. A compression molding tooling for producing production-grade vehicle components from sheet molding compound (SMC) or a bulk molding compound (BMC), the tooling being formed by additive manufacturing and configured to withstand operating pressures of 750-1500 psi and temperatures of 200-400 degrees Fahrenheit.
